(19) United States
(12) Patent Application Publication
(10) Pub. No.: US 2008/0063266 A1
(43) Pub. Date: Mar. 13, 2008

(54) IMAGE NONUNIFORMITY REDUCTION DEVICE FOR DISPLAY SYSTEM USING DIFFRACTIVE OPTICAL MODULATOR

(75) Inventor: Seung Do An, Suwon (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 11/848,077

(22) Filed: Aug. 30, 2007

(30) Foreign Application Priority Data
Aug. 30, 2006 (KR) 1020060082840

(51) Int. Cl. G06K 9/58; G09G 5/00

(52) U.S. Cl. 382/164; 345/211

(57) ABSTRACT

Disclosed herein is an image nonuniformity reduction device for a display system. The display system has a light source unit, an illumination optical unit, a diffractive optical modulator, a projection and scanning optical unit, and a screen. The image nonuniformity reduction device includes an image input unit, an image mixing unit, and an optical modulator driving circuit. The image mixing unit detects single color regions from the image data received by the image input unit, mixes a predetermined image with each of the detected single color regions, and outputs a resulting image.

### CROSS REFERENCE TO RELATED APPLICATION

This application claims the benefit of Korean Patent Application No. 10-2006-0082840, filed on Aug. 30, 2006, entitled “Reduction Apparatus of the Display Surface in the Display System using the Optical Diffractive Modulator,” which is hereby incorporated by reference in its entirety into this application.

### BACKGROUND OF THE INVENTION

1. Field of the Invention

The present invention relates to an image nonuniformity reduction device that can reduce image nonuniformity chiefly occurring in single color regions of a screen in a display system using a diffractive optical modulator, thereby reducing visual discomfort attributable to such image nonuniformity.

2. Description of the Related Art

Active research into various Flat Panel Displays (FPDs) has been actively conducted to develop subsequent generation display devices. Among them, popularized FPDs include Liquid Crystal Displays (LCDs) using the electro-optic characteristics of liquid crystal and Plasma Display Panels (PDPs) using gas discharge.

LCDs are disadvantageous in that the viewing angle thereof is narrow, the response speed thereof is slow, and the manufacturing process thereof is complicated because Thin Film Transistors (TFTs) and electrodes must be formed through a semiconductor manufacturing process.

In contrast, PDPs are advantageous in that the manufacturing process thereof is simple, and is therefore suitable for the implementation of large-sized screens, but are disadvantageous in that the power consumption thereof is high, the discharge and light emission efficiency thereof is low, and the price thereof is high.

New types of display devices, which can overcome the disadvantages of the above-described FPDs, have been developed. Recently, there has been proposed a display device that can display images using micro Spatial Light Modulators (SLMs) that are formed for respective pixels using Micro Electromechanical Systems (hereinafter abbreviated as “MEMSs”), which are based on an ultra-micro machining technology.

The SLMs are converters that are configured to modulate incident light into a spatial pattern corresponding to electrical or optical input. The incident light may be modulated with respect to phase, intensity, polarization or direction. Optical modulation can be achieved using several materials that have several electro-optic or magneto-optic effects, or material that modulates light through surface deformation.

FIG. 1 is a perspective view of a prior art open hole-based diffractive optical modulator.

Referring to the drawing, the prior art open hole-based diffractive optical modulator includes a substrate 101.

The open hole-based diffractive optical modulator further includes an insulating layer 102 that is formed on the substrate 101.

The open hole-based diffractive optical modulator further includes a lower reflective part 103 that is formed on part of the insulating layer 102 and is configured to reflect incident light that passes through the holes 106aa to 106nb of upper reflective parts 106a to 106n and the spaces between the upper reflective parts 106a to 106n.

The open hole-based diffractive optical modulator further includes a pair of side support members 104 and 104′ that allow the lower reflective part 103 to be interposed therebetween, and are formed on the surface of the substrate 101 to be spaced apart from each other.

The open hole-based diffractive optical modulator further includes a plurality of laminate support plates 105a to 105n that have side portions supported by the pair of side support members 104 and 104′, are spaced apart from the substrate 101, have central portions movable upward and downward, have holes (not shown) corresponding to the holes 106aa to 106nb formed in the upper reflective parts 106a to 106n at the central portions thereof, and constitute an array.

The open hole-based diffractive optical modulator further includes the upper reflective parts 106a to 106n that are respectively formed at the central portions of the laminate support plates 105a to 105n, have the holes 106aa to 106nb at the centers thereof, so that they reflect some incident light and allow the remaining incident light to pass through the holes 106aa to 106nb, and constitute an array.

The open hole-based diffractive optical modulator further includes a plurality of pairs of piezoelectric layers 110a to 110n and 110a′ to 110n′ that are formed over the laminate support plates 106a to 106n, are spaced apart from each other, are placed over the side support members 104 and 104′, and are configured to move the laminate support plates 106a to 106n upward and downward.

In the piezoelectric layers 110a to 110n and 110a′ to 110n′, when voltage is applied to the lower electrode layers 110aa to 110na and 110aa′ to 110na′, the piezoelectric material layers 110ab to 110nb and 110ab to 110nb′ and the upper electrode layers 110ac to 110nc and 110ac′ to 110nc, the central portions of the laminate support plates 105a to 105n move upward and downward due to the contraction and expansion of the piezoelectric material layers 110ab to 110nb and 110ab′ to 110nb′. Accordingly, the upper reflective parts 106a to 106n move upward and downward. For convenience of description, each of the laminate support plates 106a to 106n, each of the upper reflective parts 106a to 106n, and each pair of the piezoelectric layers 110a to 110n and 110a′ to 110n′ are collectively referred to as an element.

Meanwhile, when light is incident on the upper reflective parts 106a to 106n of the open hole-based diffractive optical modulator, the upper reflective parts 106a to 106n reflect part of the incident light and allow the remaining part of the incident light to pass through the holes 106aa to 106nb, and the lower reflective part 103 reflects light that has passed through the holes 106aa to 106nb of the upper reflective parts 106a to 106n.

As a result, the light reflected from the upper reflective parts 106a to 106n and the light reflected from the lower reflective part 103 forms diffracted light having several diffraction orders. The intensity of the diffracted light is highest when the difference in height between the upper reflective parts 106a to 106n and the lower reflective part 103 is an odd multiple of λ/4 where λ is the wavelength of the incident light, and is lowest when the difference in height between the upper reflective parts 106a to 106n and the lower reflective part 103 is an even multiple of λ/4.

Meanwhile, the above-described diffractive optical modulator may be used in various application fields. As an example, the above-described diffractive optical modulator may be used in a display device.

In general, the display device using the prior art diffractive optical modulator includes a light source, an illumination lens, a diffractive optical modulator, a projection system, and a screen.

The light source includes a plurality of light sources, for example, a red light source, a green light source, and a blue light source.

The illumination lens converts light, emitted from the light source, into linear parallel light, and causes the linear parallel light to enter the diffractive optical modulator.

The diffractive optical modulator produces diffracted light having a plurality of diffraction orders by modulating linear parallel light when the linear parallel light is incident thereon. In this case, the diffracted light formed by the diffractive optical modulator is linear diffracted light from the viewpoint of each diffraction order. That is, the diffracted light emitted from the diffractive optical modulator forms a linear scan line in such a way that a plurality of scanned diffracted light spots corresponding to the pixels of an image to be formed on a screen is linearly arranged.

The projection system produces a two-dimensional image by projecting a linear scan line, formed through the arrangement of a plurality of scanned diffracted light spots, onto a screen and scanning the linear scan line across the screen.

As an example, in the case of the universal HDTV standard, one image frame includes pixels corresponding to a row length K=1080 pixels×a column length L=1920 pixels. In order to output an HDTV-quality image using the above-described diffractive optical modulator, a two-dimensional image is produced by scanning a linear scan line, formed through the linear arrangement of scanned diffracted light spots corresponding to 1080 pixels, in a lateral direction.

The prior art projection and scanning optical unit of such a projection system is shown in FIG. 2. The projection and scanning optical unit produces a two-dimensional image by scanning a scan line, composed of a plurality of scanned diffracted light spots 1S generated by the diffractive optical modulator, across a screen 26.

The projection and scanning optical unit includes a condensing lens 220, a scanner 222, and a projection lens 224, and projects incident diffracted light onto a screen 226.

The condensing lens 220 condenses linear diffracted light, passed through an optical filter or dichroic filter (not shown), so that it is focused on the screen 226. Of course, a concave lens (not shown) may be provided downstream of the condensing lens 220, so that diffracted light, passed through the optical filter or dichroic filter, may be condensed, converted into parallel light and then projected onto the prism scanner 222.

The scanner 222 is an X scanning mirror, and scans an incident line image across the screen 226 from the left to the right and then from the right to the left under the control of a display electronic system, and repeats this operation. A Galvanometer mirror scanner or a polygon mirror scanner may be used as the scanner 222.

Meanwhile, in the prior art, an image is formed on a screen by scanning a scan line, composed of a plurality of diffracted light spots, using a diffractive optical modulator, therefore image nonuniformity may occur in single color regions. If so, visual discomfort may be experienced by a viewer who views an image produced on the screen by a display device using the diffractive optical modulator. That is, referring to FIG. 3, the portions of a screen indicated by circles are single color regions, in which case images formed by diffracted light spots may have different light intensities, thus resulting in image nonuniformity.

The reason for the occurrence of image nonuniformity in single color regions is that, even though the same voltage is applied to respective elements of a diffractive optical modulator, the displacements of upper reflective parts may be different, as shown in FIG. 4 (in FIG. 4, when the same voltage is applied, the first upper reflective parts 106a may be moved from location l₁ to location l₁′, and the second upper reflective parts 106b may be moved from location l2 to location l₂′, and l₁′≠l₂′). As a result, image nonuniformity occurs, notwithstanding that the same light intensity was expected to be applied to the single color regions.

### SUMMARY OF THE INVENTION

Accordingly, the present invention has been made keeping in mind the above problems occurring in the prior art, and the present invention is intended to provide an image nonuniformity reduction device that can reduce image nonuniformity chiefly occurring in single color regions of a screen in a display system using a diffractive optical modulator, thereby reducing visual discomfort attributable to such image nonuniformity.

The present invention provides an image nonuniformity reduction device for a display system, the display system having a light source unit, an illumination optical unit, a diffractive optical modulator, a projection and scanning optical unit, and a screen, the image nonuniformity reduction device including an image input unit for receiving image data from outside; an image mixing unit for detecting single color regions from the image data received by the image input unit, mixing a predetermined image with each of the detected single color regions, and outputting a resulting image; and an optical modulator driving circuit for producing driving voltage for driving the diffractive optical voltage according to the image data from the image mixing unit, and driving the diffractive optical modulator using the driving voltage.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of a prior art open hole-based diffractive optical modulator;

FIG. 2 is a block diagram showing the projection control unit of a display system using the prior art diffractive optical modulator;

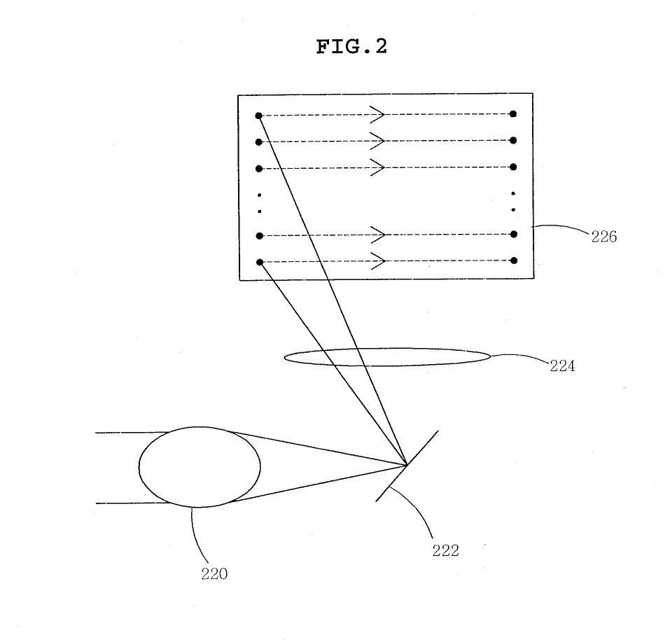

FIG. 3 is a photo illustrating single color regions of an image displayed on a screen;

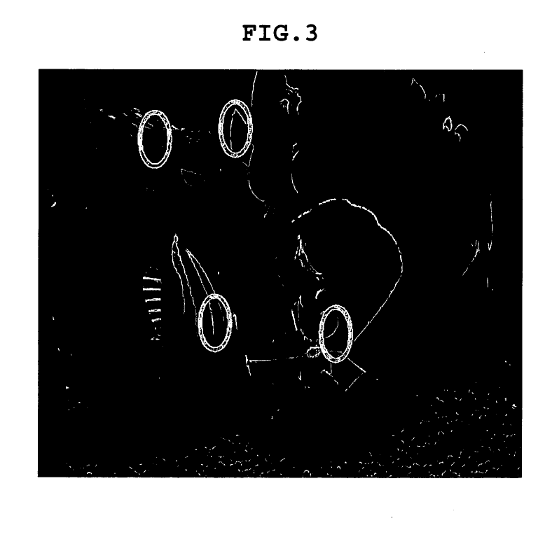

FIG. 4 is a conceptual diagram illustrating the cause of the occurrence of image nonuniformity in a display device using the prior art diffractive optical modulator;

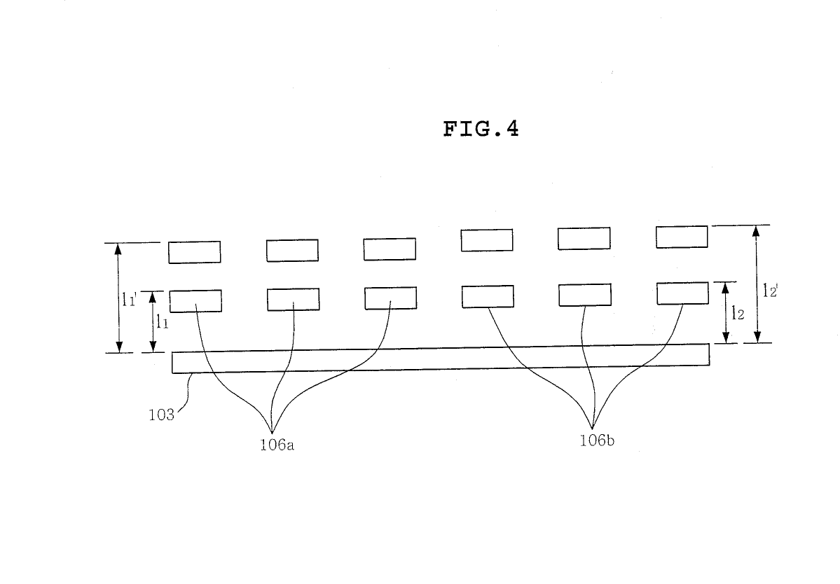

FIG. 5 is a block diagram of a display device using a diffractive optical modulator, which is equipped with an image nonuniformity reduction device according to an embodiment of the present invention;

FIG. 6 is a block diagram of the image nonuniformity reduction device according to the embodiment of the present invention;

FIG. 7 is a diagram showing the structure of an image data frame that is composed of 1080×1920 pixels;

FIG. 8A is a diagram showing an example of a 3*3 mask used by the single color region detection unit of FIG. 6, FIGS. 8B and 8C are conceptual diagrams showing an operation in which the single color region detection unit of FIG. 6 detects single color regions while moving a 3*3 mask, FIG. 8D is a diagram showing an example of values that are detected from a single color region by the single color region detection unit of FIG. 6 using a 3*3 mask, and FIG. 8E is a diagram showing an example of the random image values of a 3*3-pixel single color region produced by the random image production unit of FIG. 6; and

FIG. 9 is a diagram illustrating the transposition of laterally arranged input image data into vertically arranged image data.

### DESCRIPTION OF THE PREFERRED EMBODIMENTS

Preferred embodiments of the present invention are described in detail below with reference to the accompanying drawings.

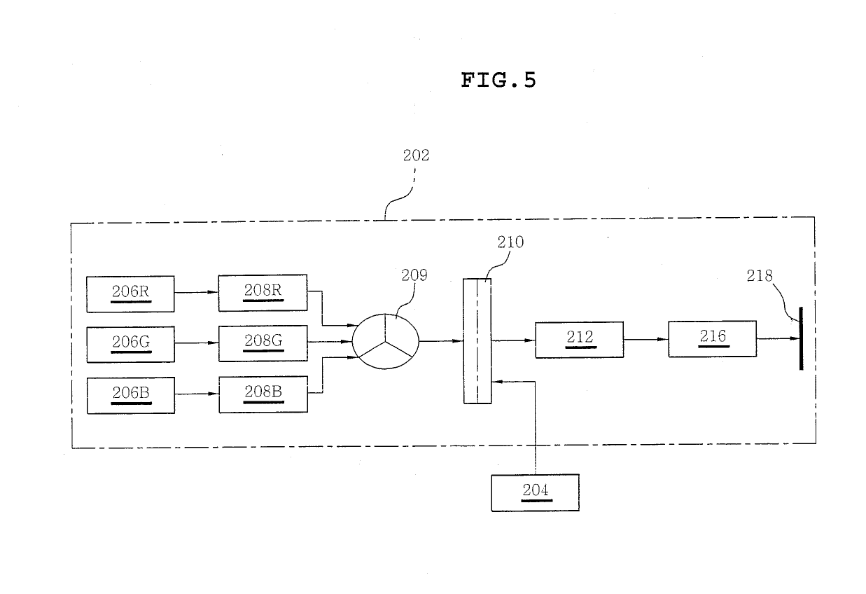

With reference to FIGS. 5 to 9, an image nonuniformity reduction device for a display device using a diffractive optical modulator according to an embodiment of the present invention is described in detail below.

FIG. 5 is a block diagram of a display device using a diffractive optical modulator, which is equipped with an image nonuniformity reduction device according to an embodiment of the present invention.

Referring to FIG. 5, the display device using a diffractive optical modulator and having an image nonuniformity reduction function according to the embodiment of the present invention includes a display optical system 202 and a display electronic system 204.

The display optical system 202 includes a red light source 206R, a green light source 206G, a blue light source 206B, an illumination optical unit 208R for a red light source, an illumination optical unit 208G for a green light source, an illumination optical unit 208B for a blue light source, a plate color wheel 209, a diffractive optical modulator 210, a Schlieren optical unit 212, a projection and scanning optical unit 216, and a screen 218.

Here, laser light sources 206R, 206G, and 206B emit laser light. The laser light has, for example, a circular section, and the intensity profile of the laser light has a Gaussian distribution.

The illumination optical units 208R, 208G and 208B convert light, emitted from the laser light sources 206R, 206G and 206B, into linear light, so that narrow, long linear light is radiated onto the diffractive optical modulator 210.

The diffractive optical modulator 210 produces diffracted light by modulating linear light emitted from the illumination optical units 208R, 208G and 208B. Here, the plate color wheel 209 is disposed between the illumination optical units 208R, 208G and 208B and the diffractive optical modulator 210, and is divided into three sections, each of the sections being formed to pass only one color light therethrough. Accordingly, when the plate color wheel 209 is rotated and beams of linear light, emitted from the illumination optical units 208R, 208G and 208B, have the same light path, linear light, which enters the diffractive optical modulator 210 via the plate color wheel 209, is time-divided. In this case, if the plate color wheel 209 is divided into, for example, an R region, a G region and a B region, linear light passes through the plate color wheel 209 in the sequence of R light, G light and B light.

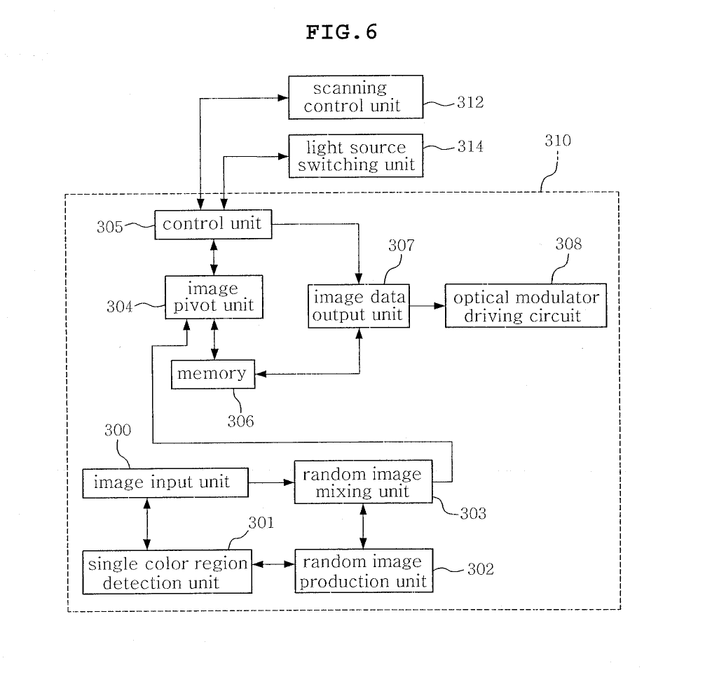

When linear light entering the diffractive optical modulator 210 is time-divided and passes through the diffractive optical modulator 210, the diffractive optical modulator 210 produces diffracted light by modulating respective beams of incident light under the control of the optical modulator driving circuit (reference numeral 310 in FIG. 6) of the display electronic system 204, and emits the produced diffracted light.

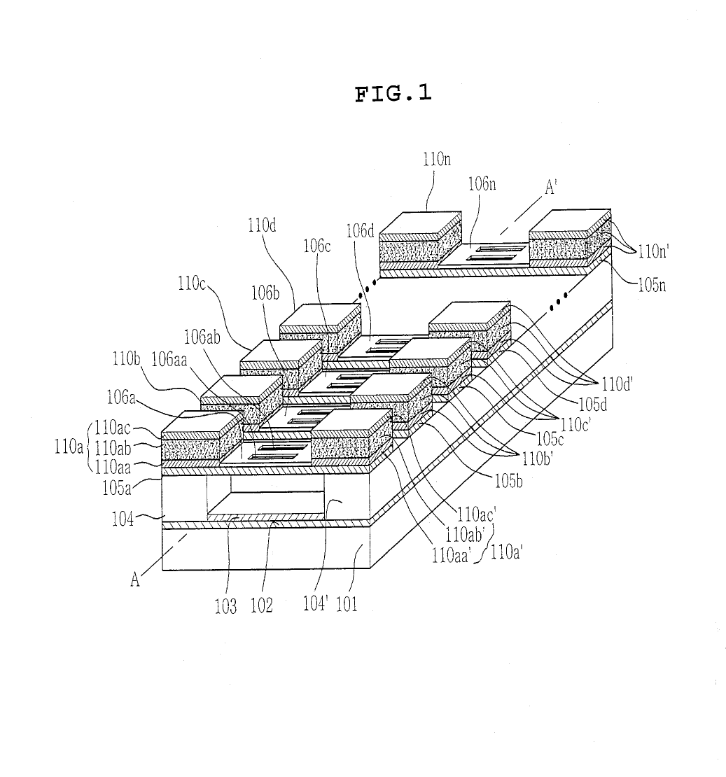

The open hole-based diffractive optical modulator shown in FIG. 1 may be used as the diffractive optical modulator 210, and any type of diffractive optical modulator may be used as the diffractive optical modulator 210.

The Schlieren optical unit 212 (which may be called a “filter unit”) separates diffracted light, modulated by the diffractive optical modulator 210, according to diffraction order, and passes diffracted light having a desired order, selected from a plurality of beams of diffracted light having respective diffraction orders, therethrough.

The Schlieren optical system 212 includes, for example, a Fourier lens (not shown) and a spatial filter or dichroic filter (not shown), and selectively passes 0th-order diffracted light or ±1st-order diffracted light, selected from incident diffracted light, therethrough.

The projection and scanning optical unit 216 produces a two-dimensional image by scanning a scan line composed of a plurality of diffracted beam spots, passed through the Schlieren optical unit 212, onto the screen 218.

The projection and scanning optical unit 216 includes a condensing lens (not shown), a scanner (not shown), and a projection lens (not shown), and projects incident diffracted light onto the screen 218.

Here, the condensing lens condenses linear diffracted light, passed through the optical filter or dichroic filter (not shown), so that it is focused on the screen 218. Of course, a concave lens (not shown) may be provided downstream of the condensing lens, so that diffracted light, passed through the optical filter or dichroic filter, may be condensed, converted into parallel light, and then projected onto the scanner.

The scanner is an X scanning mirror, and scans a line image across the screen 218 from the left to the right under the control of the display electronic system 204, and then repeats this operation.

Meanwhile, the display electronic system 204, as shown in FIG. 6, includes an image nonuniformity reduction device 310, including an image input unit 300, a single color region detection unit 301, a random image production unit 302, a random image mixing unit 303, an image pivot unit 304, a control unit 305, memory 306, an image data output unit 307 and an optical modulator driving circuit 308, a scanning control unit 312, and a light source switching unit 314.

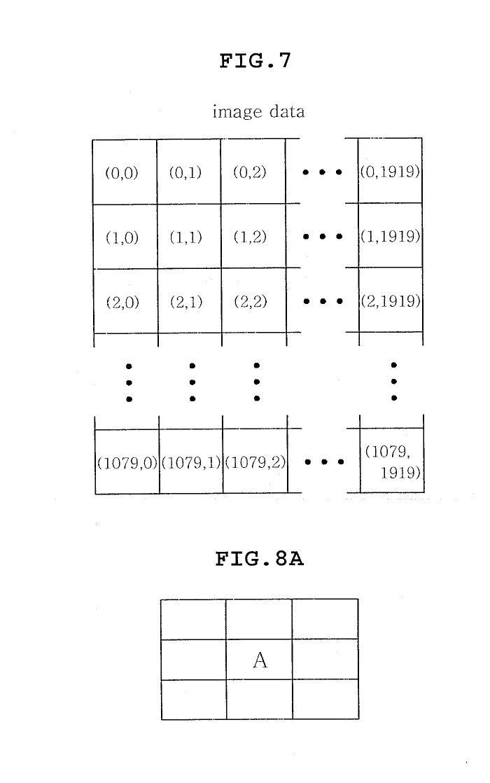

Here, the image input unit 300 receives image data from the outside, and, at the same time, receives a vertical synchronizing signal Vsync and a horizontal synchronizing signal Hsync. With regard to the input of an image, in the case of the universal HDTV standard, an image frame is composed of pixels corresponding to a row length K=1080 pixels and a column length L=1920 pixels, as shown in FIG. 7. When the image input unit 300 receives such an image frame, it stores the received image in fresh memory (not shown).

Then, the single color region detection unit 301 detects single color regions from the image frame received by the image input unit 300, and provides information about the detected single color regions to the random image production unit 302.

Here, a method of detecting single color regions using a mask may be used as a IS method by which the single color region detection unit 301 detects single color regions from the image frame received by the image input unit 300.

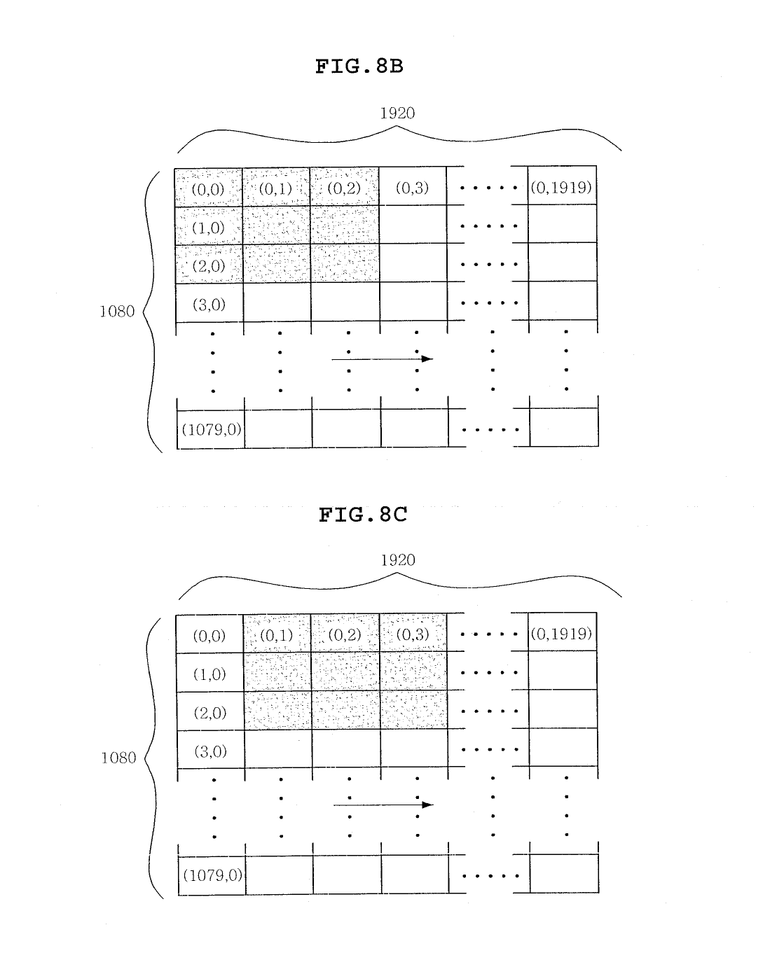

The single color region detection unit 301 detects single color regions while moving, for example, a 3*3 mask, shown in FIG. 8A, from the first pixel of the image frame to the last pixel, as shown in the conceptual diagrams of FIG. 8B and FIG. 8C. The single color region detection unit 301 locates the mast on the first part of the image, sets the pixel value of any one of the pixels within the mask as a reference value, and obtains differences between the reference value and the values of the input image.

In this case, when the values of an input image received by the image input unit 300 are represented using, for example, 1-255 gray levels, a single color region may be detected by setting the gray level of any one of the pixels under a mask as a reference value and calculating differences between the reference value and the gray levels of the other pixels.

That is, a single color region may be detected in such a way that the pixel value A of row 2 and column 2 in FIG. 8A is set to a reference value, differences between the reference value and the values of the other pixels are calculated, as shown in FIG. 8D, the differences are added together, the sum is divided by the number of pixels, and whether the quotient is equal to or larger than a predetermined value is determined. In FIG. 8D, the quotient is −1+1−1−1−3−1=− 6/16=−0.375, therefore the region of interest is a single color region if the criterion value for determining that a region of interest is a single color region is set to a value equal to or less than 1.

Of course, although the method that is used by the single color region detection unit 301 in the above example is a method using a mask, the present invention is not limited to this method.

Furthermore, although the mast that is used by the single color region detection unit 301 to detect single color regions is a 3*3 mask, the present invention is not limited to such a mask, but n*m masks (where n is not identical to m), in addition to n*n masks, may be used.

Moreover, although the single color region detection unit 301 obtains differences, adds the differences together and divides the sum by the number of pixels within a mask so as to detect single color regions, the present invention is not limited to this, but single color regions can be detected using standard deviation or variation.

Meanwhile, the single color region detection unit 301 notifies the random image production unit 302 of information about the sections of single color regions when the single color regions are detected. In the case where the method by which the single color region detection unit 301 notifies the random image production unit 302 of section information uses an n*n mask, notification of information about a first pixel and a last pixel or information about pixels in respective corners may be provided. Alternatively, the single color region detection unit 301 may notify the random image production unit 302 of a resulting value obtained to detect a single color region, for example, −0.375.

Then, when information about the sections of single color regions is input from the single color region detection unit 301, the random image production unit 302 sends a randomly distributed random image to the random image mixing unit 303.

In this case, the random image provided by the random image production unit 302 may be a random image that is produced and provided at the moment that section information is input from the single color region detection unit 301, or a random image that has been randomly produced already. An example of such a random image produced by the random image production unit 302 is shown in FIG. 8E, in which values not exceeding a specific value are randomly arranged.

Of course, the random image production unit 302 may determine the range of available values that can be used to produce a random image based on a calculated value provided by the single color region detection unit 301. That is, the random image production unit 302 may determine the range of values, from the minimum value to the maximum value, that can be arranged on a random image, based on a calculated value input from the single color region detection unit 301, or may determine a standard deviation value or a variation value based on such a calculated value.

Meanwhile, the random image production unit 302 produces a random image based on the information about the sections of single color regions input from the single color region detection unit 301, and sends the produced random image to the random image mixing unit 303.

Thereafter, the random image mixing unit 303 mixes the single color region, detected in the image frame that was input from the image input unit 300, with the random image that was input from the random image production unit 302, and outputs a resulting image to the image pivot unit 304.

Although the method by which the random image production unit 302 produces a random image that may be added to or subtracted from an image received by the image input unit 300 has been described above, a random image capable of replacing a single color region of an image received by the image input unit 300 may be produced. If so, the random image mixing unit 303 replaces a single color region with a random image, produced by the random image production unit 302, rather than mixing the single color region with the random image.

The image pivot unit 304 converts laterally input image data into vertically arranged image data by performing a data transposition of converting laterally arranged image data into vertically arranged data, and then stores the vertically arranged image data in the memory 306. The reason why a data transposition is required in the image pivot unit 304 is that a scan line emitted from the diffractive optical modulator 210 is composed of vertically arranged diffracted light spots corresponding to 1080 pixels, therefore display through lateral scanning is required.

That is, as shown in FIG. 7, standard image data is arranged in a lateral direction. However, since the diffractive optical modulator 210, as shown in FIG. 1, has a plurality of actuation elements arranged in a vertical direction, it is required to display a plurality of pieces of image data while scanning the image data in a lateral direction.

Accordingly, in order to form an image frame composed of 1080×1920 pixels using the diffractive optical modulator 210 by scanning a scan line, 1080 pieces of vertically arranged data are required.

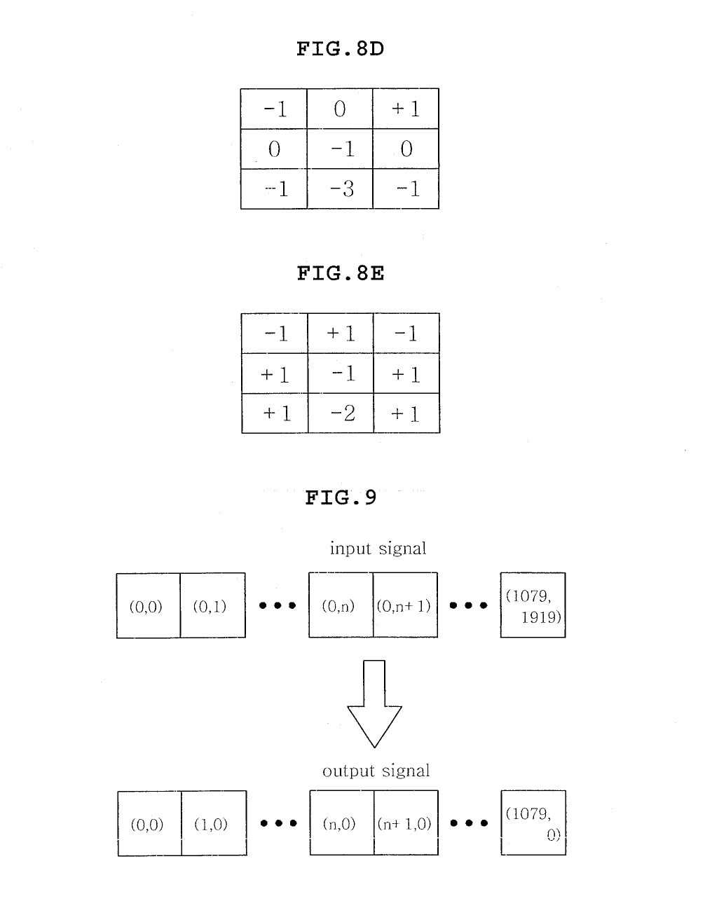

In other words, FIG. 7 shows the structure of an image data frame that is composed of 1080×1920 pixels. The image data shown in FIG. 7 is input from the outside in a lateral direction in the sequence of (0,0), (0,1), (0,2), and (0,3), However, since 1080 pieces of vertically arranged data are required to generate an image frame using the diffractive optical modulator 210, the input image data must be transposed from laterally arranged image data to vertically arranged image data, as shown in FIG.9.

During scanning, the image data output unit 307 sequentially reads the image data, transposed by the image pivot unit 304 and stored in the memory 306, from a first column to a last column, and outputs the read image data.

In response to the image data from the image data output unit 307, the optical modulator driving circuit 308 drives the diffractive optical modulator 210 and modulates incident light, thus forming diffracted light having image information.

That is, in the driving of the diffractive optical modulator 210, the optical modulator driving circuit 308 drives the diffractive optical modulator 210 and modulates incident light during scanning, thus forming diffracted light having image information.

The optical source driving circuit 314 selectively supplies power to the laser light sources 206R, 206G and 206B. The scanning driving circuit 312 controls the scanner of the projection and scanning optical unit 216 so that scanning can be performed.

Meanwhile, although the horizontal scanning has been described as an example, the present invention can be applied to vertical scanning in the same manner.

Furthermore, although the open hole-based diffractive optical modulator, in which open holes are formed in a diffractive optical modulator, has been described above, the present invention can be applied to a diffractive optical modulator that has the same structure but has no open holes.

Moreover, although the diffractive optical modulator has been described as including a plurality of open holes the longitudinal sides of which are arranged in the direction in which reflective parts cross a substrate, it may include a plurality of open holes the longitudinal sides of which are arranged in a direction perpendicular to that direction.

As described above, the present invention is advantageous in that it reduces image nonuniformity, thereby reducing visual discomfort attributable to such image nonuniformity.

Furthermore, the present invention is advantageous in that it reduces image nonuniformity chiefly and visually detected from single color regions in a display system using a diffractive optical modulator, thus mitigating visual discomfort attributable to such image nonuniformity.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An image nonuniformity reduction device for a display system, the display system having a light source unit, an illumination optical unit, a diffractive optical modulator, a projection and scanning optical unit, and a screen, the image nonuniformity reduction device comprising:
an image input unit for receiving image data from outside;
an image mixing unit for detecting single color regions from the image data received by the image input unit, mixing a predetermined image with each of the detected single color regions, and outputting a resulting image; and
an optical modulator driving circuit for producing driving voltage for driving the diffractive optical voltage according to the image data from the image mixing unit, and driving the diffractive optical modulator using the driving voltage.

2. The image nonuniformity reduction device as set forth in claim 1, wherein the image that is mixed with the image data by the image mixing unit is a random image.

3. The image nonuniformity reduction device as set forth in claim 1, wherein the image mixing unit comprises an image pivot unit for converting laterally input image data into vertically arranged image data by performing data transposition of converting laterally arranged image data, input into the image input unit, into vertically arranged image data.

4. The image nonuniformity reduction device as set forth in claim 1, further comprising memory for storing the image data transposed by the image pivot unit;
wherein the image mixing unit comprises an image data output unit for sequentially reading the image data from the memory in a sequence from data in a first column to data in a last column and outputting the read image data.

5. The image nonuniformity reduction device as set forth in claim 1, wherein the image mixing unit comprises:
a single color region detection unit for detecting single color regions from the image input from the image input unit; and
a random image mixing unit for mixing each of the single color regions, detected by the single color region detection unit, with a random image.

6. The image nonuniformity reduction device as set forth in claim 5, wherein the image mixing unit comprises a random image production unit for producing the random image for the single color region detected by the single color region detection unit, and providing the random image to the random image mixing unit.

7. The image nonuniformity reduction device as set forth in claim 1, wherein the image mixing unit detects the single color regions from the image data, received from the image input unit, using a mask.

8. The image nonuniformity reduction device as set forth in claim 7, wherein the image mixing unit obtains a standard deviation from the image data, received from the image input unit, using the mask based on a specific value within the mask, and detects each of the single color regions using the standard deviation.

9. The image nonuniformity reduction device as set forth in claim 7, wherein the image mixing unit obtains variation from the image data, received from the image input unit, using the mask based on a specific value within the mask, and detects each of the single color regions using the variation.

10. The image nonuniformity reduction device as set forth in claim 7, wherein the mask used by the image mixing unit is an n*n mask.

11. The image nonuniformity reduction device as set forth in claim 7, wherein the mask used by the image mixing unit is an n*m mask (n≠m).
